(19) United States
(12) Patent Application Publication
(10) Pub. No.: US 2007/0197266 A1
(43) Pub. Date: Aug. 23, 2007

(54) Automatic dialing through wireless headset

(75) Inventor: Yu-Chang Chang, Hsin-Chu City (TW)

Correspondence Address: BIRCH STEWART KOLASCH & BIRCH, PO BOX 747, FALLS CHURCH, VA, 22040-0747, US

(73) Assignee: AirDigit Incorporation

(21) Appl. No.: 11/359,512

(22) Filed: Feb. 23, 2006

(51) Int. Cl. H04M 1/00

(52) U.S. Cl. 455/575.2

(57) ABSTRACT

An automatic dialing method through a wireless headset is provided, which contains two modules: a headset module implemented in the wireless headset; and a master module implemented in a communication device. When the wireless headset and the communication device are idle, a user triggers the headset module by activating a combination of buttons on the wireless headset. The headset module in turn triggers the master module via a wireless connection between the wireless headset and the communication device. The master module then immediately retrieves records from a phone book pre-installed in the communication device, and then speaks out the “name” of each record to the user. When hearing the name of the desired call parted from the wireless headset, the user again triggers the headset module to instruct the master module to dial the number stored in the same phone record.

### BACKGROUND OF THE INVENTION

1. Field of the Invention

The present invention generally relates to wireless headsets, and more particularly to a automatic dialing method through wireless headsets.

2. The Prior Arts

By facilitating the use of cellular phones while the user is driving or working, wireless headset has become one of the most important accessories to cellular phone communications.

A wireless headset is usually hung over a user's ear and has a wireless connection with the cellular phone via a communication protocol such as Bluetooth®. Then, by turning on the auto-answering mode of the cellular phone, the cellular phone can automatically pick up an incoming call and the user can engage in conversation through the wireless headset while the user is driving, walking, or working on a computer. Despite its convenience in answering incoming calls, the wireless headset currently cannot provide an equally convenient scenario in making outbound calls. The user still has to manually operate the keypad on the cellular phone to make calls first, and the user can then engage in a conversation with the called party. The applicability of the wireless headset is therefore significantly constrained.

On the other hand, some models of cellular phones are equipped with voice dialing capability, which recognizes some numeric code or the name of the called party spelled or spoken out by the user after comparing the user's voice with some pre-installed patterns, and then automatically dials a corresponding number. Voice dialing indeed provides a certain degree of convenience. However, it never gains widespread popularity due to the limited recognition capability of the cellular phone, which frequently misinterprets noises as valid dialing commands and mistakenly makes outbound calls.

### SUMMARY OF THE INVENTION

Accordingly, the present invention provides an automatic dialing method, allowing a user to make outbound calls through the wireless headset as conveniently as answering incoming calls.

The present method contains two modules: a headset module implemented in a wireless headset; and a master module implemented in a communication device. The two modules operate independently and interact with each other via a wireless connection between the wireless headset and the communication device. When the wireless headset and the communication device are idle (i.e., not making and answering calls and not engaging in conversation), a the user triggers the headset module by activating a combination of buttons on the wireless headset. The headset module in turn triggers the master module via their wireless connection therebetween. The master module then immediately retrieves records from a phone book pre-installed in the communication device, and then speaks out the “name” of each record to the user via the wireless connection sequentially. When hearing the name of the desired call party from the wireless headset, the user again triggers the headset module. The headset module then instructs the master module to dial the number stored in the same phone record.

According to the present method, a wireless headset user can easily and conveniently make outbound calls while driving, walking, working on a computer, or engaging in some activities that cannot free a hand to make a manual dial. After the call is connected, the user then can engage in conversation through the wireless headset.

The foregoing and other objects, features, aspects and advantages of the present invention will become better understood from a careful reading of the detailed description provided herein below with appropriate reference to the accompanying drawings.

### BRIEF DESCRIPTION OF THE DRAWINGS

FIG. 1a is a flow diagram showing the processing steps of the headset module according to an embodiment of the present invention.

FIG. 1b is a flow diagram showing the processing steps of the master module according to an embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention is implemented in a communication device, and in a wireless headset of the communication device. Throughout this specification, the term “communication device” refers to a mobile communication device such as a GSM cellular phone, a 3G cellular phone, a PHS phone, a Smart Phone, a PDA (personal digital assistant) equipped with mobile communication capability, a WiFi phone having WLAN (wireless local area network) connection capability, etc. These mobile communication devices are all capable of allowing their users to conduct real-time, two-way voice communications via a public mobile communication network. As to the wireless headset, it can have over-the-ear or over-the-head design, or it can be a condenser or piezoelectric microphone-equipped headset. The present invention does not require the wireless headset to be of any specific design or to be based on a specific technology. The wireless headset and the communication device have a short-ranged duplex wireless connection therebetween. This wireless connection is usually compliant with the Bluetooth® specification. However, the spirit of the present invention is not limited by Bluetooth®. Any currently known or to-be-developed short-ranged duplex wireless connection protocols should be considered to be within the scope of the present invention.

The term “communication device” also refers to a computing device such as desktop computer, notebook computer, or other types of computer that is capable of (1) connecting to the public mobile communication network and providing real-time, two-way voice communications by the installation of some specific adaptors or interfaces such as a GSM adaptor card; or (2) connecting to the Internet and providing real-time, two-way voice communications through voice-over-IP (VoIP) or similar technology by the installation of some specific application programs; or (3) connecting to the PSTN (public switched telephone network) via a telephone line plugged into a built-in voice/fax modem and providing real-time, two-way voice communications. These computing devices should also be able to establish wireless connection with the wireless headset via, for example, a Bluetooth® dongle or a built-in Bluetooth® module.

Throughout this specification, the portion of the present invention implemented in the wireless headset is referred to as the “headset module,” and the other portion implemented in the communication device is referred to as the “master module.” The two modules run independently and interact with each other via their wireless connection. For the present invention's point of view, whether the communication device is a mobile communication device or a computing device is of no significance; both are a platform for the execution of the master module. Therefore, for simplicity, a mobile communication device is taken as an example while the principles and spirit of the present invention described in the following is applicable to appropriate computing devices as well.

The headset module is usually an integral part of the firmware of the wireless headset and is usually is installed in the wireless headset when it is manufactured. On the other hand, the master module is separately installed onto the mobile communication device, which usually has a standard operating system such as PalmOS®, WinCE®, Symbian®, to name just a few. However, the use of a proprietary operating system by the mobile communication does not conflict with the present invention either. In addition, for the present invention to work, the wireless connection between the wireless headset and the mobile communication device has to be already established and functional. Usually, using Bluetooth® as example, this requires some preliminary procedure such as pairing to be conducted in advance. In the following, it is assumed that the preliminary procedure is already performed and the wireless connection is established and functioning properly.

Usually one or more buttons are provided on the body of the wireless headset for functions such as turning on/off, volume up/down, etc. With these existing buttons, the headset module of the present invention accepts the activation of at least two combinations of buttons. Here the term “combination of buttons” refers to the action of clicking or pressing down one or more buttons simultaneously or continuously for various periods of time. The two combinations of buttons supported by all embodiments of the present invention represent “start automatic dialing” and “dial this number” respectively. In some alternative embodiments, additional combinations of buttons representing “stop automatic dialing” and “go to next record” are also supported. More details about these combinations of buttons will be given in the following.

The master module contains a phone book, which is usually stored in the non-volatile memory of the mobile communication device. The phone book can hold a number of records, each of which contains at least two pieces of information in a name field and a telephone number field respectively. The name field could contain text describing a called party's name, company name, etc., which is referred to as a text tag. The name field could also contain a pre-recorded voice segment speaking a called party's name, company name, etc., which is referred to as a voice tag. In some embodiments, the name field of a phone record contains only a text tag or a voice tag; while in some other embodiments, the name filed contains both text and voice tags. The maintenance of the phone book such as adding a new record, editing an existing record, removing an existing record, recording a voice tag, etc., could be conducted by a user directly via the man-machine interface of the mobile communication device; or it could be conducted by the user on a computer and then uploaded to the mobile communication device. Please note that, in some embodiments, the phone book is actually the built-in phone book of the wireless communication device, instead of one provided separately by the master module. There are also some embodiments in which master module supplements the built-in phone book of the mobile communication device with the voice tag function.

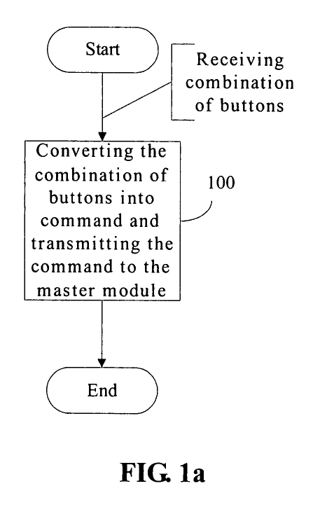

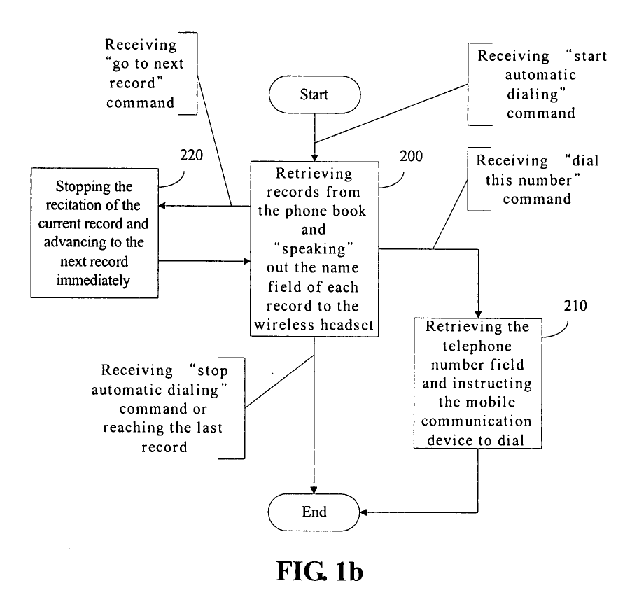

FIGS. 1a and 1b are flow diagrams showing the processing steps of the headset module and the master module respectively. As depicted, the headset module is rather straightforward. As long as the wireless headset is idle (i.e., the wireless headset is turned on and there is no conversation in progress), the foregoing combinations of buttons would trigger the headset module to enter the step 100, or the headset module is repeatedly executing the step 100 to check for the occurrence of the combinations of buttons. In step 100, the headset module receives the activated combination of the buttons, converts it to a corresponding command, and sends the command to the master module via the wireless connection.

If the command issued from the headset module means “start automatic dialing,” as long as the mobile communication device is idle (i.e., the mobile communication device is turned on and there is no conversation in progress), the master module is triggered to enter the step 200. In step 200, the master module retrieves records out of the phone book, one at a time in a certain order. For each record, the master module “speaks” out the information contained in the name field to the wireless headset via the wireless connection. If the name field contains a text tag, the master module uses software-generated synthesized voice to “pronounce” the words of the text tag. The pronunciation of each letter can be pre-recorded and stored on the mobile communication device and the master module “spells” out the text tag in a letter by letter manner. On the other hand, if the name field contains a voice tag, the master module simply “plays” the voice tag to the wireless headset. If the name field contains both a text tag and a voice tag, the master module could always play the voice tag by default and, when a record without a voice tag is encountered, then the text-to-speed function of the master module is used. There are various other ways to implement the text-to-speed function and it is not limited to the foregoing methods only. If an additional “start automatic dialing” command arrives while the master module hasn't finished processing the previous “start automatic dialing” command, the latter one will be ignored.

Please note that the records can be retrieved based on the order they are added to the phonebook, or based the order sorted by the name field or the telephone number field, or based on the order manually adjusted by the user, or based on the order dynamically produced by the master module based on the frequency of usage of these records. No matter how the order is established, the master module recites each record until all records are processed and, then, the master module is automatically terminated as shown in FIG. 1b. In an alternative embodiment, the master module will repeat reciting the entire list of records by going back to the first record and the repetition will be continued for indefinite number of times until the “stop automatic dialing” command is received.

If the “go to next record” command is received from the headset module during the master module's reciting of the records, the processing flow continues to the step 220, in which the recitation of the current record is immediately stopped, and the master module advances to the next record and returns to the step 200 to continue recitation. On the other hand, if the “dial this number” command or the “stop automatic dialing” command is received, the recitation of records is immediately stopped. For the latter, the master module automatically terminates itself. For the former, the processing flow enters the step 210, in which the master module retrieves the telephone field of the currently recited record or the last record recited (but the next record is not yet processed), and instructs the mobile communication device to dial the destination number contained in the telephone number field. Please note that, after this point, the ordinary operation of the wireless headset and the wireless communication device is resumed.

As a brief summary, a typical scenario of the present invention is as follows. A user is wearing a wireless headset which has already established a wireless connection with a mobile communication device. At any time, especially when the user is driving, walking, working on a computer, or engaging in any activity, the user can activate the combination of the buttons that represents “start automatic dialing,” and then the user can hear from the wireless headset a list of names recited by the master module. During the recitation, the user can activate the combination of buttons that represents “go to next record” to jump to the next record quickly. When the user hears the name of the called party being recited, the user activates the combination of buttons that represents “dial this number,” the mobile communication device will automatically dial the called party's telephone number as recorded in the record's telephone number field. If the user would like to give up making an outbound call, the user can at any time activate the combination of buttons that represents “stop automatic dialing,” the recitation will stop immediately and the wireless headset and the wireless communication device will all return to their idle state.

Please note that, in some embodiments of the present invention, more combinations of buttons are supported to provide additional functionality such as halting/resuming the recitation, going back to the first record, speeding up/down the recitation, etc. The processing these combinations of buttons is actually very similar to the processing of the “go to next record,” “dial this number,” or “stop automatic dialing” combinations, and the foregoing description can be generalized to cover these additional combinations.

The present invention can also be integrated with the aforementioned voice dialing function. For example, in some embodiments, the combinations of buttons are all replaced by voice commands. To prevent mistakenly triggering the present invention, there are also some embodiments which replace all combinations of buttons with voice commands except the “start automatic dialing” combination. However, misinterpretation would be difficult to avoid when the voice command conflicts with the recitation of records. Therefore, some embodiments of the present invention adopt a simplified version of voice dialing. In these embodiments, all commands are activated by combinations of buttons except the “dial this number” command, which is issued based on the volume (not the words) the user speaks to the wireless headset and received by the mobile communication device. More specifically, when the user hears the desired called party's name during the recitation of the records, the user only has to say “dial” or any other word in a loud voice to instruct the mobile communication device to dial this called party. As long as the volume of the voice is greater than some threshold, the master module will consider that it has received a “dial this number” command. In this way, misinterpretation can be effectively reduced while making the present invention even more convenient.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of automatic dialing through a wireless headset, said method having a headset module and a master module, said master module being implemented in a communication device capable of connecting to an appropriate network and conducting real-time two-way voice communication, said headset module being implemented in said wireless headset having an appropriate functional wireless connection established to said communication device, said headset module comprising the steps of:
receiving a command from said wireless headset and transmitting said command to said master module via said wireless connection; and
said master module comprising the steps of:
when receiving a “start automatic dialing” command, retrieving at least a record from a phone book according to an appropriate order with each of said records comprising a name field and a telephone number field, reciting the name field of each record to said wireless headset via said wireless connection;
when receiving a “dial this number” command during the recitation of said records, immediately stopping the recitation of said records and instructing said communication device to dial the number contained in said telephone number field of the currently or most recently recited record.

2. The method according to claim 1, wherein said wireless connection is compliant with the Bluetooth® specification.

3. The method according to claim 1, wherein at least one of said commands is recognized by said wireless headset by the activation of a specific combination of buttons.

4. The method according to claim 1, wherein at least a command is recognized by the voice of said command.

5. The method according to claim 1, wherein said “dial this number” command is recognized when the volume of voice received by said communication device is larger than an appropriate threshold.

6. The method according to claim 1, wherein said appropriate order is dynamically determined based on the frequency of usage of said records.

7. The method according to claim 1, wherein said name field of said records contains text.

8. The method according to claim 7, wherein said master module recites said name field by pronouncing the text contained in said name field via synthesized voice.

9. The method according to claim 7, wherein said master module recites said name field by playing pre-recorded voice files for each letter of the text contained in said name field.

10. The method according to claim 1, wherein said name field of said records contains a pre-recorded voice segment.

11. The method according to claim 10, wherein said master module recites said name field by playing said voice segment.

12. The method according to claim 1, wherein said phone book is the built-in phone book of said communication device.

13. The method according to claim 1, wherein said phone book is provided by said master module.

14. The method according to claim 1, wherein said master module further comprises the steps of:
when a “stop automatic dialing” command is received during the recitation of said records, immediately stopping the recitation of the current record and terminates said master module automatically.

15. The method according to claim 1, wherein said master module further comprises the steps of:
when a “go to next record” command is received during the recitation of said records, immediately stopping the recitation of the currently recited record and advancing to the next record.

16. The method according to claim 1, wherein, when said master module finishes reciting all records contained in said phone book, said master module automatically terminates itself.

17. The method according to claim 1, wherein, when said master module finishes reciting all records contained in said phone book, said master module automatically restarts from the first record again.
